(19) United States
(12) Patent Application Publication
(10) Pub. No.: US 2012/0258409 A1
(43) Pub. Date: Oct. 11, 2012

(54) DISTRIBUTED INJECTION WITH FUEL FLEXIBLE MICRO-MIXING INJECTORS

(76) Inventors: Adel B. Mansour, Mentor, OH (US); Erlendur Steinthorsson, Pepper Pike, OH (US); Brian P. Hollon, Moncks Corner, SC (US); Jeffrey R. Lehtinen, Concord Township, OH (US); Robert A. Frindt, Chardon, OH (US); Raman Ras, Concord, OH (US); Michael D. Carrel, Jefferson, OH (US); Jeffrey M. Melzak, Beachwood, OH (US)

(21) Appl. No.: 13/444,226

(22) Filed: Apr. 11, 2012

Related U.S. Application Data
(60) Provisional application No. 61/474,067, filed on Apr. 11, 2011.

(51) Int. Cl. F23L 7/00; F02M 63/00

(52) U.S. Cl. 431/2; 239/533.2

(57) ABSTRACT

Provided is an injector having a plurality of micro-mixing nozzles having axes thereof pointing radially inwardly or outwardly with respect to a main axis of the injector and a plurality of micro-mixing nozzles having axes thereof extending axially with respect to the main axis of the injector. The arrangement of micro-mixing nozzles provides a means for fast and efficient mixing of fuels, such as highly reactive fuels including hydrogen. The arrangement of micro-mixing nozzles also achieves low NOx emissions.

### RELATED APPLICATIONS

This application claims the benefit of U.S. Provisional Application No. 61/474,067 filed Apr. 11, 2011, which is hereby incorporated herein by reference.

### FIELD OF INVENTION

The present invention relates generally to turbine engines, and more particularly to injectors for turbine engines having a plurality of micro-mixing nozzles.

### BACKGROUND

A turbine engine typically includes an outer casing extending radially from an air diffuser and a combustion chamber. The casing encloses a combustor for containment of burning fuel. The combustor includes a liner and a combustor dome, and an igniter is mounted to the casing and extends radially inwardly into the combustor for igniting fuel.

The turbine also typically includes one or more fuel injectors for directing fuel from a manifold to the combustor. Each fuel injector typically has an inlet fitting connected either directly or via tubing to a fuel manifold. Appropriate valves and/or flow dividers can be provided to direct and control the flow of fuel through the nozzle and/or fuel passage.

### SUMMARY OF INVENTION

The present invention provides an injector having a plurality of micro-mixing nozzles having axes thereof pointing radially inwardly or outwardly with respect to a main axis of the injector and a plurality of micro-mixing nozzles having axes thereof extending axially with respect to the main axis of the injector. The arrangement of micro-mixing nozzles provides a means for fast and efficient mixing of fuels, such as highly reactive fuels including hydrogen. The arrangement of micro-mixing nozzles also achieves low NOx emissions.

According to one aspect of the invention, an injector includes a first plurality of micro-mixing nozzles disposed in a circumferential array surrounding a main axis of the injector, wherein axes of the micro-mixing nozzles point radially inwardly with respect to the main axis, and at least a second plurality of micro-mixing nozzles having axes thereof extending axially with respect to the main axis of the injector.

In an embodiment, the injector includes a plurality of injector modules each including one or more of the first plurality micro-mixing nozzles.

In another embodiment, the injector includes a support structure for housing the plurality of injector modules, the support structure defining an inner chamber having first and second axial ends.

In yet another embodiment, the injector includes an end wall enclosing the first axial end, the end wall housing the second plurality of micro-mixing nozzles.

In a further embodiment, the injector includes a support structure for housing the first plurality of micro-mixing nozzles, the support structure defining an inner chamber having first and second axial ends, and an end wall housing the second plurality of micro-mixing nozzles, the end wall enclosing the first axial end. The end wall may be semispherical wall extending into the inner chamber.

According to another aspect of the invention, an injector includes a first plurality of micro-mixing nozzles disposed in a circumferential array surrounding a main axis of the injector, wherein axes of the micro-mixing nozzles point radially inwardly with respect to the main axis and a second plurality of micro-mixing nozzles disposed in a circumferential array surrounding the main axis of the injector and disposed interiorly of the first plurality of micro-mixing nozzles, wherein axes of the micro-mixing nozzles point radially outwardly with respect to the main axis.

In an embodiment, the injector includes a first support structure for housing the first plurality of micro-mixing nozzles, the support structure defining an inner chamber having first and second axial ends, and a second support structure for housing the second plurality of micro-mixing nozzles, the second support structure having first and second axial ends and projecting into the inner chamber from the first axial end of the first support structure.

In another embodiment, the injector includes an end wall extending radially outwardly from the first axial end of the second support structure, the end wall and second support structure enclosing the first axial end.

In yet another embodiment, the injector includes a second end wall enclosing a second axial end of the second support structure.

In a further embodiment, the injector includes a plurality of micro-mixing nozzles housed in the second end wall, the nozzles having axes thereof extending axially with respect to the main axis of the injector.

In another embodiment, the injector includes a first plurality of injector modules each including one or more of the first plurality micro-mixing nozzles and a second plurality of injector modules each including one or more of the second plurality micro-mixing nozzles, wherein the first support structure houses the first plurality of injector modules and the second support structure houses the second plurality of injector modules.

According to another aspect of the invention, a method for enhancing flame stability of a flame in a cavity of an injector is provided, the method including injecting a mixture of fuel and air from a first plurality of micro-mixing nozzles disposed in a circumferential array surrounding a main axis of the injector into the cavity, wherein axes of the micro-mixing nozzles point radially inwardly with respect to the main axis, and injecting a mixture of fuel and air from at least a second plurality of micro-mixing nozzles having axes thereof extending axially with respect to the main axis of the injector into the cavity.

The foregoing and other features of the invention are hereinafter described in greater detail with reference to the accompanying drawings.

### BRIEF DESCRIPTION OF THE DRAWINGS

FIG. 1 is a fragmentary cross-sectional view of a portion of an exemplary turbine engine illustrating a plurality of injectors in communication with a combustor;

FIG. 2 is a perspective view of an exemplary injector according to the invention;

FIG. 3 is another perspective view of the injector shown in FIG. 2;

FIG. 4 is a partial perspective view of an exemplary support structure of the injector;

FIG. 5 is a perspective view of an exemplary injector module of the injector;

FIG. 6 is a perspective view of an exemplary injector module having a first surface and a second recessed surface;

FIG. 7 is a perspective view of another exemplary injector module having a pilot sheltering baffle;

FIG. 8 is a perspective view of another exemplary injector according to the invention;

FIG. 9 is a perspective view of yet another exemplary injector according to the invention;

FIG. 10 is a perspective view of still another exemplary injector according to the invention;

FIG. 11 is another perspective view of the injector shown in FIG. 10;

FIG. 12 is a perspective view of yet another exemplary injector according to the invention;

FIG. 13 is a perspective view of a further exemplary injector according to the invention;

FIG. 14 is a perspective view of another exemplary injector according to the invention;

FIG. 15 is a perspective view of still another exemplary injector according to the invention;

FIG. 16 is a cross-sectional view of the injector shown in FIG. 15;

FIG. 17 is a cross-sectional view of the injector shown in FIG. 2 connected to a fuel delivery manifold;

FIG. 18 is a cross-sectional view of the injector shown in FIG. 9 connected to a fuel delivery manifold; and

FIG. 19 is a cross-sectional view of the injector shown in FIG. 10 connected to the fuel delivery manifold;

FIG. 20 is a partial perspective view of the injector module illustrating a plurality of micro-mixing nozzles; and

FIG. 21 is a partial perspective view of an exemplary support structure housing the injector modules.

### DETAILED DESCRIPTION

The principles of the present application have particular application to injectors for turbine engines using hydrogen or natural gas for electric power generation and thus will be described below chiefly in this context. It will of course be appreciated, and also understood, that the principles of the invention may be useful in other applications including, other injector applications, such as in engines for furnaces, boilers, aircrafts etc., using various liquid and gas fuel sources.

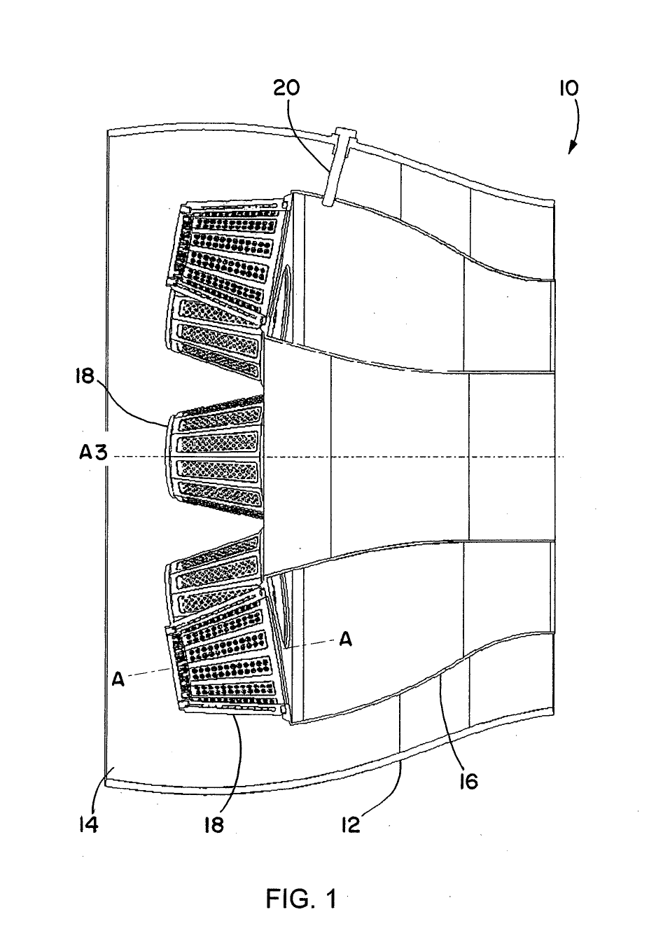

Referring now in detail to the drawings and initially to FIG. 1, a turbine engine is illustrated generally at 10. The turbine engine 10 includes an outer casing 12 extending radially of an air diffuser 14 and a combustor 16 for containment of burning fuel. Inserted into the combustor is at least one injector 18, and in the illustrated embodiment a plurality of injectors annularly arranged. An igniter, indicated generally at 20, may be mounted to the casing 12 and extends inwardly into the combustor 16 for igniting the fuel and air mixture. Alternatively, at least one igniter may be mounted in each of the injectors 18 and extends inwardly into a chamber in the injectors for igniting a fuel and air mixture.

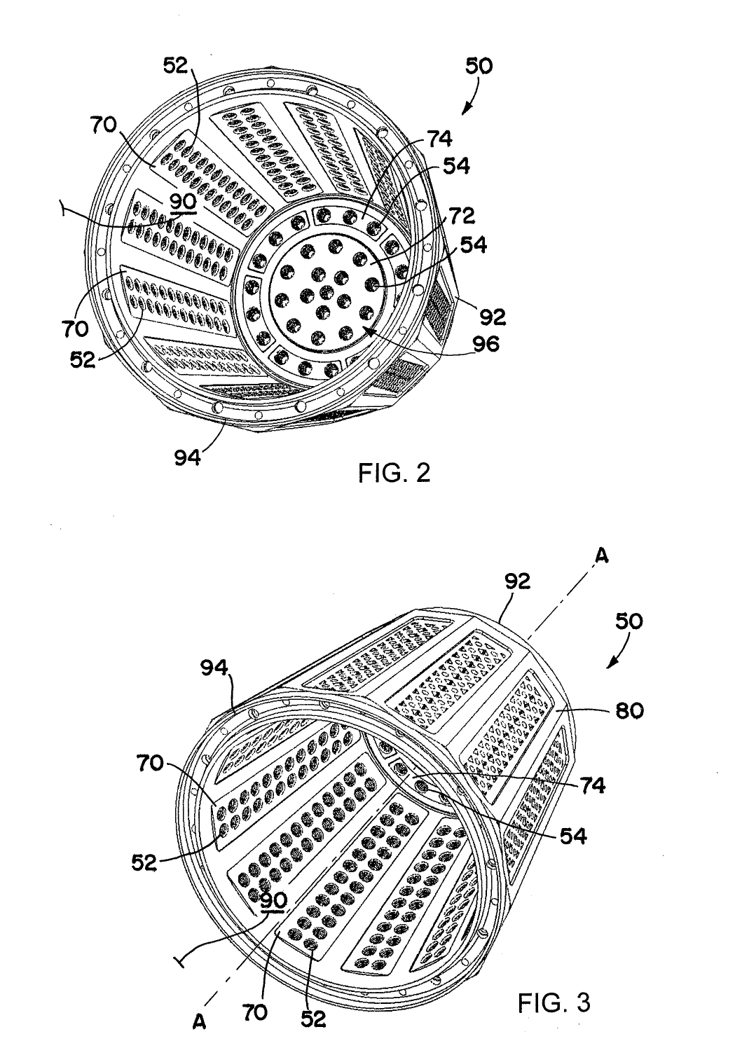

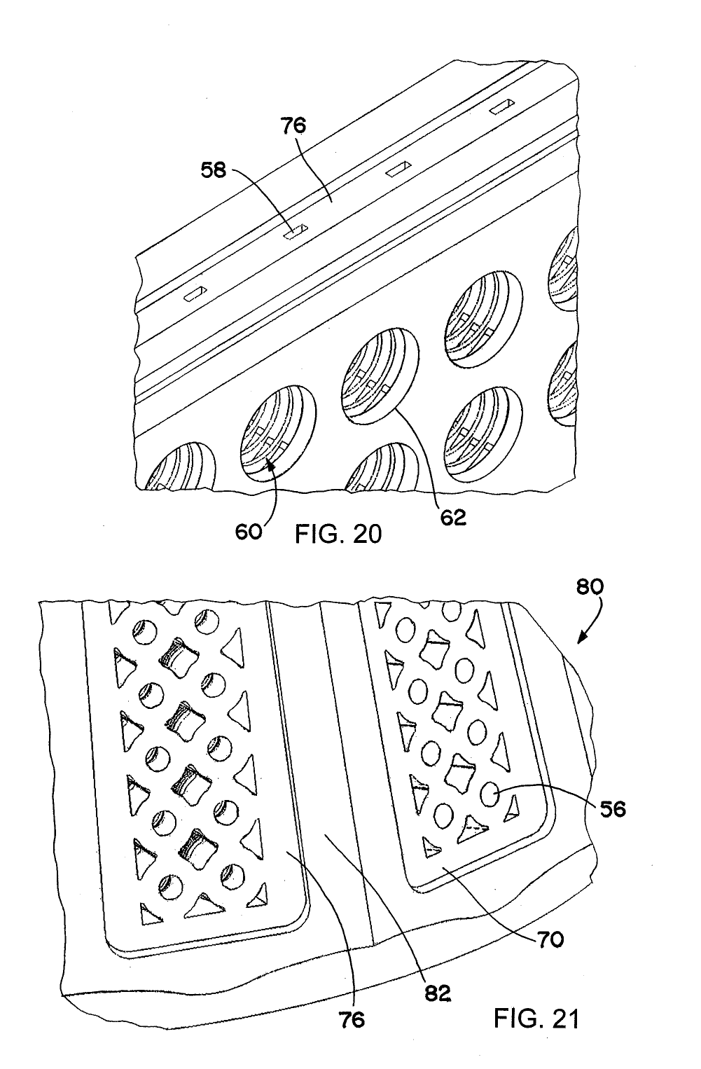

Turning now to FIGS. 2 and 3, an exemplary injector is shown at reference numeral 50. The injector 50 may be positioned in the combustor 16 in a similar manner to the injector 18. The injector 50 includes a plurality of micro-mixing nozzles 52 and 54, which may be any suitable nozzle, such as the micro-mixing nozzles disclosed in U.S. Pat. Nos. 5,435,884, 7,021,562 and 7,083122, which are hereby incorporated herein by reference. As shown in FIGS. 5, 20 and 21, each micro-mixing nozzle 52 and 54 includes an inlet 56 for receiving air, at least one slot 58 in communication with a manifold for receiving fuel, a mixing chamber 60 for at least partially mixing the air and fuel, and an outlet 62 for delivering the air and fuel mixture. In one embodiment, one or more of the micro-mixing nozzles includes at least two slots, where one slot receives a pilot circuit from a first manifold and one slot receives a main circuit from a second manifold. The outlets 62 of the micro-mixing nozzles may be sized to have any suitable diameter for delivering the air and fuel mixture. For example, the outlets may have a diameter between one quarter of an inch and one inch, and preferably about one half of an inch.

The micro-mixing nozzles may be straight, converging or diverging in a direction of flow, and the air flow therethrough may be axial, radial, or a combination thereof. For example, the micro-mixing nozzles may be straight nozzles having non-swirling axial through flow, converging nozzles having non-swirling radial inflow, diverging nozzles having a radial or axial swirler, etc. If the micro-mixing nozzles have radial through flow, the nozzles may include swirling air inlets providing swirling through flow, non-swirling air inlets providing non-swirling through flow, or a combination thereof, where the swirl can be both clockwise or counter clockwise about the flow direction. The fuel inlets can be staggered axially and/or tangentially. The micro-mixing nozzles may be fabricated in any suitable manner, such as by macrolamination, rapid prototyping, casting, machining, a combination thereof, etc., and may be formed by one or more components.

Various structures may be provided to control and manipulate the air flow into the micro-mixing nozzles. For example, a plate may be provided with one or more holes to reduce the axial velocity and control the size of turbulent flow features passing through the plate. The plate may be a removable insert or may be formed integrally with the nozzle. Alternatively, an axial swirler may be provided, with or without a center hole, that is inserted at least partially into an air circuit of the nozzle. The air swirler may be a removable insert or may be formed integrally with the nozzle.

Referring again to FIGS. 2 and 3, the injector 50 includes a first plurality of micro-mixing nozzles 52 and at least a second plurality of micro-mixing nozzles 54. For an outside-in injector, the first plurality of micro-mixing nozzles 52 is disposed in a circumferential array surrounding a main axis A of the injector 50, wherein axes of the first plurality of micro-mixing nozzles 52 point radially inwardly with respect to the main axis A. The second plurality of micro-mixing nozzles 54 has axes thereof extending axially with respect to the main axis A of the injector 50. For an inside-out injector, the first plurality of micro-mixing nozzles 52 has axes that point radially outward with respect to the main axis A, while the axes of the second plurality of micro-mixing nozzles extend axially with respect to the main axis. In both outside-in and inside-out injectors, the micro-mixing modules 52 and 54 prevent flashback during operation and reduce mixing time of the air and fuel.

The injector 50 also includes injector modules 70 each including one or more of the first plurality of micro-mixing nozzles 52 and injector modules 72 and 74 each including one or more of the second plurality of micro-mixing nozzles 54. As shown in FIG. 5, each injector module 70 has associated therewith one or more passages 76 for receiving fuel. For example, the injector modules may include a first passage for receiving a pilot circuit and a second passage for receiving a main circuit. It will be appreciated that injector modules 72 and 74 may be formed similarly to the injector module 70. The injector modules may be fabricated in any suitable manner, such as by macrolamination, rapid prototyping, such as direct metal deposition or direct metal laser sintering, casting, a combination thereof, etc. Additionally, the injector modules may be formed in any suitable shape wherein the micro-mixing nozzles are oriented in any suitable manner.

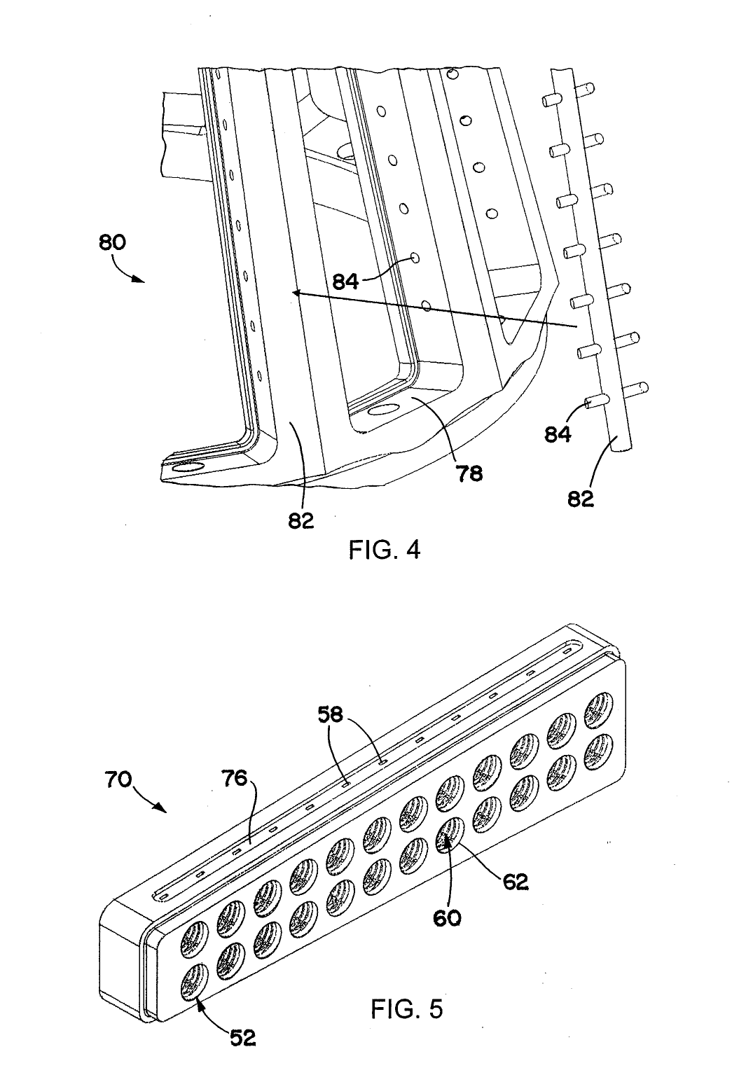

The injector modules 70 are housed in a support structure 80 and secured to the support structure by any suitable means, such as brazing or welding. FIG. 4 illustrates the support structure 80 with the injector modules removed. The injector modules 70 may be evenly spaced around the support structure 80 as shown, or spaced in any other suitable arrangement, and may extend substantially the entire axial length of the support structure from a first axial end 92 to a second axial end 94. The injector modules 70 may also direct an air and fuel mixture substantially in a radially-inward direction toward the main axis A or in a non-radial direction.

The support structure 80 defines a chamber 90 having the first and second axial ends 92 and 94. The first axial end 92 of the support structure is enclosed by an end wall 96 that is generally perpendicular to the support structure 80, and the second axial end serves as a discharge end. The support structure is shown having a conical configuration tapering outwardly from the first axial end 92 to the second axial end 94, although it will be appreciated that any suitable shape may be used for the support structure. The support structure may be fabricated in any suitable manner, such as by macrolamination, rapid prototyping, casting, machining, a combination thereof, etc., and may be formed from one or more components joined in any suitable manner, such as by welding, brazing etc.

The support structure 80 includes a plurality of substantially rectangular openings 78 for receiving the injector modules 70. It will be appreciated, however, that the openings may be any suitable size and shape. As shown in FIG. 4, the support structure includes one or more passages 82 for receiving fuel from one or more fuel manifolds, which may be integral with or separate from the support structure, and for delivering the fuel to the injector modules. The passages 82 can include a plurality of openings 84 for communicating with the passages 76 in the injector modules. As shown in FIG. 21, each opening 84 provides fuel to a passage 76 between a pair of slots 58. The support structure may alternatively include a plurality of passages, such as a first passage for receiving a pilot circuit and a second passage for receiving a main circuit. Additionally or alternatively, the fuel manifold may be coupled directly to the passages 76 in the injector modules 70 to deliver fuel to the injector modules.

Similar to the injector modules 70, the injector modules 72 and 74 are housed in the end wall 96 in any suitable manner. As shown, the end wall 96 includes an opening for receiving the injector module 72 and a plurality of openings for receiving the injector modules 74. It will be appreciated, however, that the openings may be any suitable size and shape. Similar to the support structure 80, the end wall 96 may include one or more passages for receiving fuel from one or more fuel manifolds, which may be integral with or separate from the end wall, and for delivering the fuel to the injector modules. For example, the end wall may include a first passage for receiving a pilot circuit and a second passage for receiving a main circuit similar to the support structure. Additionally or alternatively, a fuel manifold may be coupled directly to the passages 76 and 78 in the injector modules 72 and 74 to deliver fuel to the injector modules. Moreover, the passages in the end wall may be in communication with the passages in the support structure. The end wall may be fabricated in any suitable manner, such as by macrolamination, rapid prototyping, casting, machining, a combination thereof, etc., and may be formed from one or more components joined in any suitable manner, such as by welding, brazing etc.

The injector module 72 may be a circular injector module housed in a central portion of the end wall 96 and having micro-mixing nozzles arranged within the module 72 in any suitable manner. The injector modules 74 may be housed in the end wall in a region surrounding the injector module 72 and the micro-mixing nozzles may be arranged in any suitable manner. The injector modules 72 and 74 may be arranged on a planar or non-planar surface of the end wall and direct an air and fuel mixture parallel to the main axis A or at an angle relative to the main axis.

By arranging the injector modules 70, 72 and 74 as shown, flame stability is improved through interaction of the flames from the micro-mixing nozzles 52 and 54, for example when operating on low BTU fuels and fuels with low flame speeds. The arrangement also enables one injector module to enhance flame stability and robustness of another injector module through flame interaction when desired, for example for high flame speed fuels. The arrangement additionally allows for interaction between injector modules to be controlled during staging and piloting and for an increase in an effective area of the injector to power an engine. By using injector modules arranged on at least two axes, the injectors can be compact, i.e., having a high heat release rate per unit volume.

Referring again to FIGS. 1-3, pressurized air flows from the diffuser section to an outside of the injector 50, i.e. outside-in. The air then enters the micro-mixing nozzles 52 in the injector modules 70 and the micro-mixing nozzles 54 in the injector modules 72 and 74 via the inlets 56. The air mixes with fuel provided to the slots 58 from the manifold, and the air and fuel are partially or completely mixed in the mixing chambers 60, which may be one or more swirl chambers. The mixture then exits the outlets 62 into the chamber 90 as a jet, such that a plurality of injection points is provided. The igniter then ignites the mixture and flames are produced that exit the injector at the second axial end 94.

Alternatively, pressurized air flows from the diffuser section to the chamber 90, i.e. inside-out. The air then enters the inlets 56 on an inner wall of the injector modules, mixes with fuel, and then exits the outlets 62 into the combustor surrounding the injector. The mixture is then ignited by an igniter extending inwardly into the combustor 16.

The injector modules 70, 72 and 74 allow for multiples stages of fuel injection from the micro-mixing nozzles. For example, in a lower power state, i.e. pilot, the mixture could be injected from just the micro-mixing nozzles 54 in the injector module 72 and/or 74, providing flames at an equivalence ratio for low emissions and flame stability without detrimental interaction such as quenching with air flowing through the injector modules 70. The injector could then transition to a slightly higher power state by injecting the mixture from the micro-mixing nozzles 54 in the injector modules 72 and 74. The injector could then transition to a full power state by injecting the mixture form the micro-mixing nozzles 52 in injector modules 70 and micro-mixing nozzles 54 in the injector modules 72 and 74. It will also be appreciated that the mixture may be injected from the micro-mixing nozzles 52 and 54 in any suitable variation.

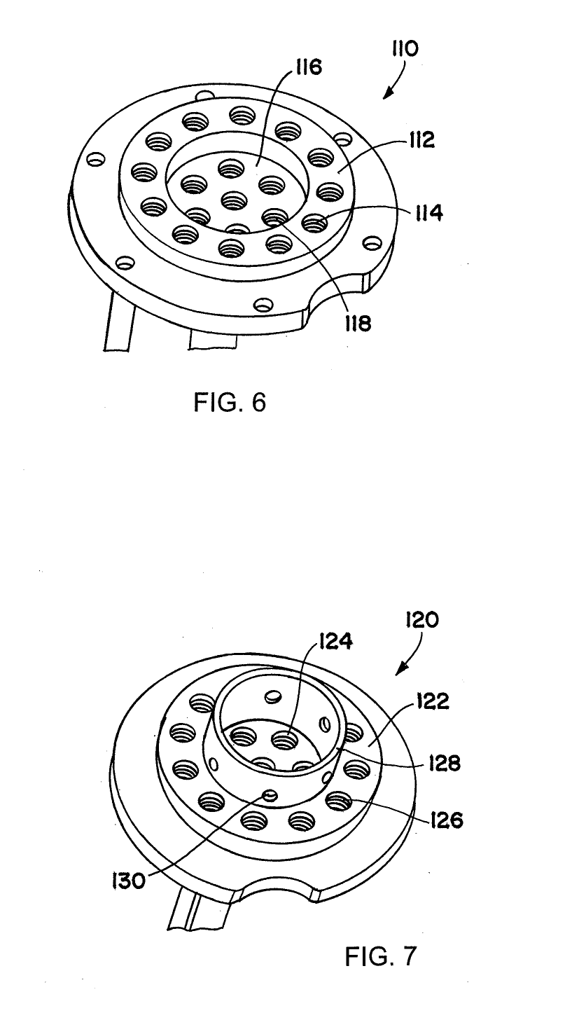

Turning now to FIG. 6, an injector module 110 may be provided that can replace one or more of the injector modules 70, 72 and 74 for varying power states of the injector. The injector module 110 includes a first surface 112 including a first set of micro-mixing nozzles 114 and a second surface 116 including a second set of micro-mixing nozzles 118. The second surface 116 is recessed relative to the first surface 112 for at least partially sheltering a flame produced by the micro-mixing nozzles 118 from air flow through the micro-mixing nozzles 114. Sheltering the flame produced by micro-mixing nozzles 118 enhances flame stability when injecting the mixture from the micro-mixing nozzles 118 and not the nozzles 114, and prevents the flame from the micro-mixing nozzles 118 from being quenched. Sheltering the flame also enhances flame stability when operating both set of micro-mixing nozzles 114 and 118 for ultra lean conditions.

Similar to FIG. 6, FIG. 7 illustrates an injector module 120 provided to replace one or more of the injector modules 70, 72 and 74. The injector module 120 includes a surface 122 having an inner set of micro-mixing nozzles 124 and an outer set of micro-mixing nozzles 126. The injector module also includes a pilot sheltering baffle 128 for at least partially sheltering the flame produced by the inner micro-mixing nozzles 124 from air flow through the micro-mixing nozzles 126. The baffle 128 may optionally include cross-fire holes 130 for cross propagation.

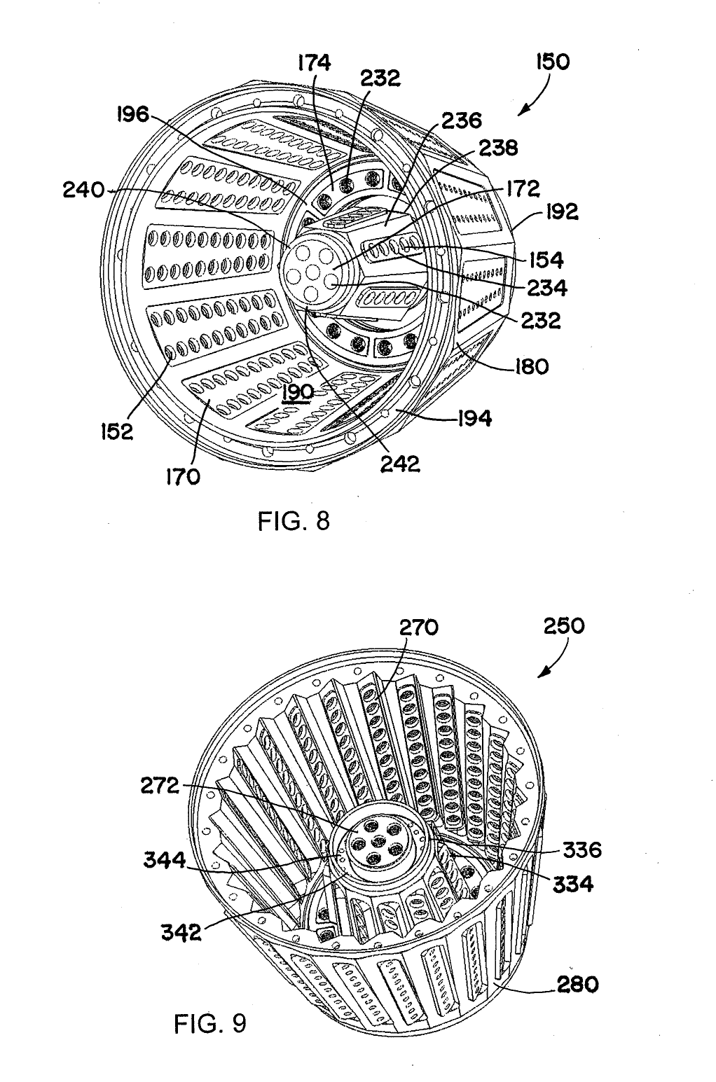

Turning now to FIG. 8, an exemplary embodiment of the injector is shown at 150. The injector of FIG. 8 is substantially the same as the above-referenced injector 50, and consequently the same reference numerals but indexed by 100 are used to denote structures corresponding to similar structures in the injectors. In addition, the foregoing description of the injector 50 is equally applicable to the injector 150 except as noted below. Moreover, it will be appreciated upon reading and understanding the specification that aspects of the injectors may be substituted for one another or used in conjunction with one another where applicable.

Referring now to FIG. 8, the injector 150 includes a first plurality of micro-mixing nozzles 152, a second plurality of micro-mixing nozzles 154, and at least a third plurality of micro-mixing nozzles 232. The first plurality of micro-mixing nozzles 152 is disposed in a circumferential array surrounding a main axis A of the injector 150, wherein axes of the micro-mixing nozzles 152 point radially inwardly with respect to the main axis. The second plurality of micro-mixing nozzles 154 is disposed in a circumferential array surrounding the main axis A of the injector 150 and disposed interiorly of the first plurality of micro-mixing nozzles, wherein axes of the micro-mixing nozzles 154 point radially outwardly with respect to the main axis A. The third plurality of micro-mixing nozzles 232 has axes thereof extending axially with respect to the main axis A of the injector 150.

The injector 150 includes injector modules 170 each including one or more of the first plurality of micro-mixing nozzles 152, injector modules 172 and 174 each including one or more of the third plurality of micro-mixing nozzles 232, and injector modules 234 each including one or more of the second plurality of micro-mixing nozzles 154. The injector modules 170 are housed in a first support structure 180 and secured to the support structure by any suitable means, such as brazing or welding. The first support structure 180 includes a plurality of substantially rectangular openings for receiving the injector modules 170, and defines a chamber 190 having first and second axial ends 192 and 194.

The first axial end 192 of the support structure 180 is enclosed by a second support structure 236 and an end wall 196, the end wall housing the injector modules 174 being generally perpendicular to the support structure 180. The second axial end 194 serves as a discharge end. The first support structure is shown having a conical configuration tapering outwardly from the first axial end 192 to the second axial end 194, although it will be appreciated that any suitable shape may be used for the support structure.

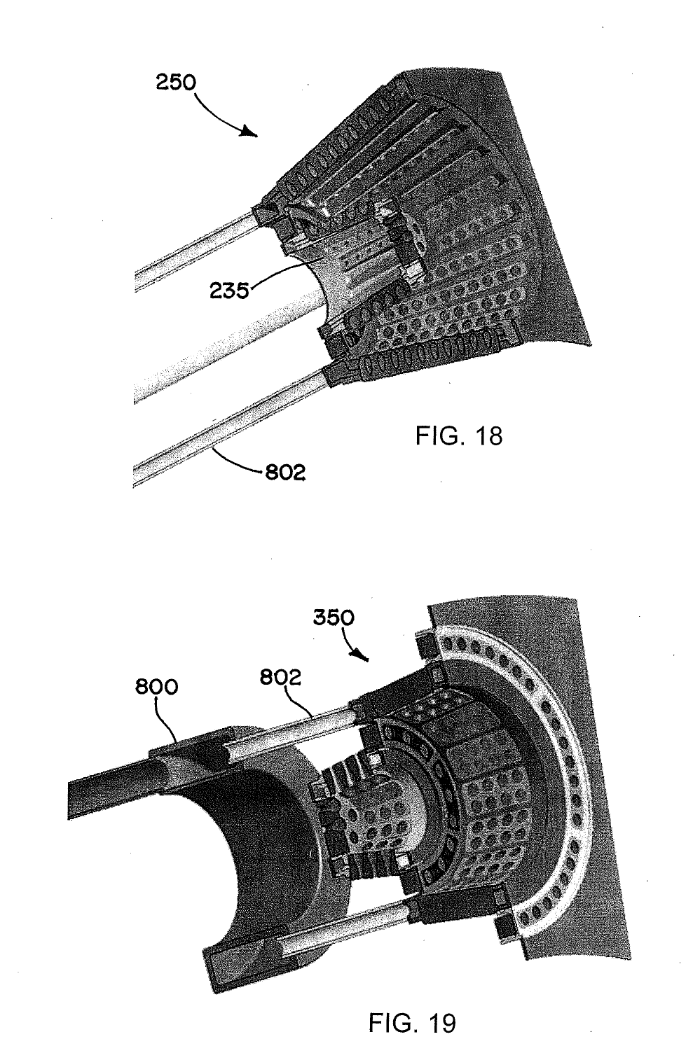

The second support structure 236 houses the injector modules 234 and defines a chamber 235 (FIG. 18) having first and second axial ends 238 and 240. The second support structure 236 projects into the inner chamber 190 from the first axial end 192 of the first support structure 180, and the chamber 235 is provided to receive air provided to enter the inlets of the micro-mixing nozzles 154. The end wall 196 extends radially outwardly from the first axial end 238 of the second support structure 236 such that the end wall 196 and second support structure enclose the first axial end 192 of the first support structure 180. It will be appreciated that the end wall 196 and the second support structure 236 may be integrally formed or may be separate components coupled in any suitable manner, such as by brazing.

The injector 150 also includes a second end wall 242 enclosing the second axial end 240 of the second support structure 236, the second end wall housing the injector module 172. The second end wall 242 includes one or more passages for receiving fuel from one or more fuel manifolds similar to the first end wall 196.

Similar to the first support structure 180, the second support structure 236 has a conical configuration tapering outwardly from the first axial end 238 to the second axial end 240, although it will be appreciated that any suitable shape may be used for the support structure. The injector modules 234 housed in the support structure 236 may be evenly spaced around the support structure 236, or spaced in any other suitable arrangement, and may extend substantially the entire axial length of the second support structure from the first axial end 238 to the second axial end 240. The injector modules 234 may also direct an air and fuel mixture substantially in a radially-outward direction from the main axis A or in a non-radial direction.

Pressurized air flows from the diffuser section to an outside of the injector 150 and to the cavity 235. The air then enters the micro-mixing nozzles 152 in the injector modules 170, the micro-mixing nozzles 154 in the injector modules 234, and the micro-mixing nozzles 232 in the injector modules 172 and 174 via the inlets 56. Alternatively, the injector can receive in the chamber 190 pressurized air from the diffuser, where the air enters the inlets of the micro-mixing nozzles in the chamber 190. In either embodiment, the mixture of fuel and air may be injected from any suitable variation of the micro-mixing nozzles to provide multiple stages of fuel injection.

Turning now to FIG. 9, an exemplary embodiment of the injector is shown at 250. The injector of FIG. 9 is substantially the same as the above-referenced injector 150, and consequently the same reference numerals but indexed by 100 are used to denote structures corresponding to similar structures in the injectors. In addition, the foregoing description of the injector 150 is equally applicable to the injector 250 except as noted below. Moreover, it will be appreciated upon reading and understanding the specification that aspects of the injectors may be substituted for one another or used in conjunction with one another where applicable.

Referring now to FIG. 9, the injector 250 includes injector modules 270 and 334 are configured at an angle relative to the support structures 280 and 336 to direct the fuel and air mixture in a non-radial direction. In this orientation, a net swirl will be generated on a downstream side of the injector modules. Additionally, the second end wall 342 houses the injector module 272 in a central portion of the end wall 342 and includes a recessed surface 344 extending radially outwardly from the central portion. Although the recessed surface is shown without injector modules or micro-mixing nozzles, it will be appreciated that the recessed surface may house any suitable number and configuration of injector modules and micro-mixing nozzles.

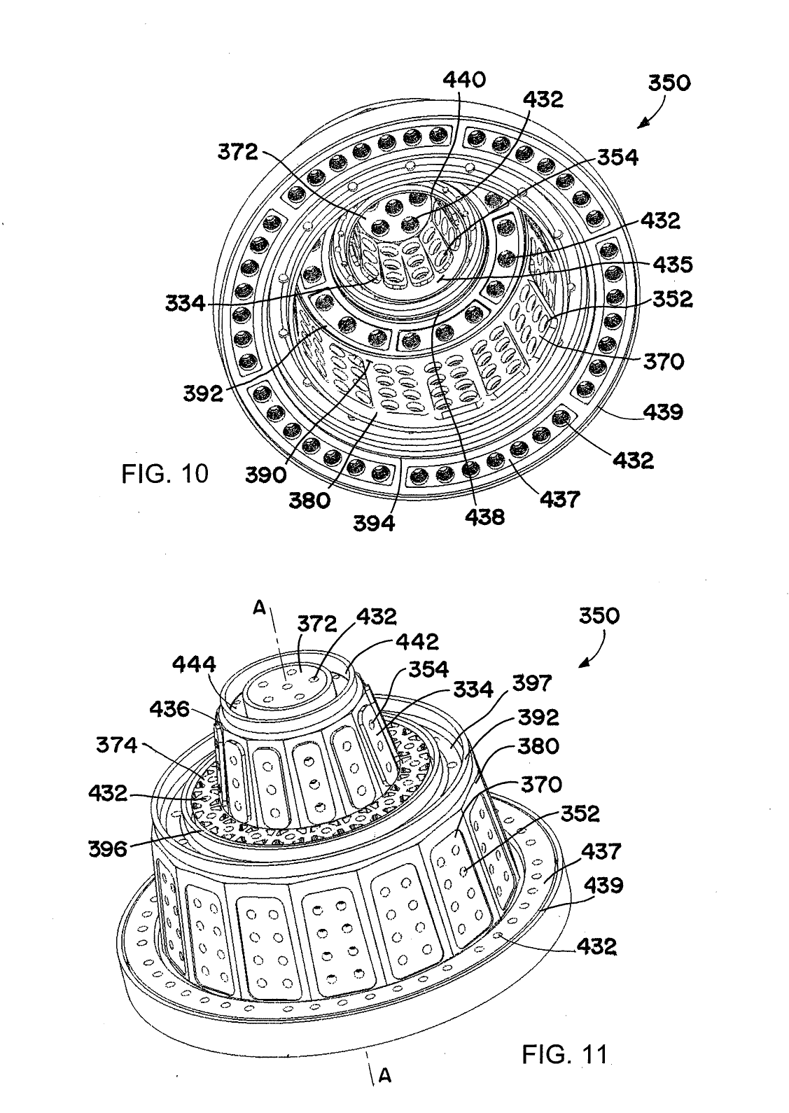

Turning now to FIGS. 10 and 11, an exemplary embodiment of the injector is shown at 350. The injector of FIGS. 10 and 11 is substantially the same as the above-referenced injector 50, and consequently the same reference numerals but indexed by 300 are used to denote structures corresponding to similar structures in the injectors. In addition, the foregoing description of the injector 50 is equally applicable to the injector 350 except as noted below. Moreover, it will be appreciated upon reading and understanding the specification that aspects of the injectors may be substituted for one another or used in conjunction with one another where applicable.

Referring now to FIGS. 10 and 11, the injector 350 includes a first plurality of micro-mixing nozzles 352, a second plurality of micro-mixing nozzles 354, and at least a third plurality of micro-mixing nozzles 432. The first plurality of micro-mixing nozzles 352 is disposed in a circumferential array surrounding a main axis A of the injector 350, wherein axes of the micro-mixing nozzles 352 point radially inwardly with respect to the main axis. The second plurality of micro-mixing nozzles 354 is disposed in a circumferential array surrounding the main axis A of the injector 350 upstream of the micro-mixing nozzles 352, wherein axes of the micro-mixing nozzles 354 point radially inwardly with respect to the main axis. The third plurality of micro-mixing nozzles 432 has axes thereof extending axially with respect to the main axis A of the injector 350.

The injector 350 includes injector modules 370 each including one or more of the first plurality of micro-mixing nozzles 352, injector modules 372, 374, and 437 each including one or more of the third plurality of micro-mixing nozzles 432, and injector modules 334 each including one or more of the second plurality of micro-mixing nozzles 354. The injector modules 370 are housed in a first support structure 380 and secured to the support structure by any suitable means, such as brazing or welding. The first support structure 380 includes a plurality of substantially rectangular openings for receiving the injector modules 370, and defines a chamber 390 having first and second axial ends 392 and 394.

The first axial end 392 of the support structure 380 is enclosed by a second support structure 436 and an end wall 396, the end wall housing the injector modules 374 and being generally perpendicular to the support structure 380. The second axial end 394 serves as a discharge end and has extending radially outwardly therefrom a flanged surface 439 that houses the injector modules 437.

The second support structure 436 houses the injector modules 434 and defines a chamber 435 having first and second axial ends 438 and 440. The second support structure 436 projects away from the first axial end 392 of the first support structure 380 and the inner chamber 390, i.e. upstream of the first support structure, and the chamber 435 is provided to receive air injected from the micro-mixing nozzles 354. The end wall 396 extends radially outwardly from the first axial end 438 of the second support structure 436 such that the end wall 396 and second support structure enclose the first axial end 392 of the first support structure 380. The end wall 396 may also include a recessed portion 397.

The injector also includes a second end wall 442 enclosing the second axial end 440 of the second support structure 436, the second end wall housing the injector module 372. The second end wall 442 includes one or more passages for receiving fuel from one or more fuel manifolds in a similar manner to the first end wall 396. The second end wall 442 houses the injector module 372 in a central portion of the end wall 442 and includes a recessed surface 444 extending radially outwardly from the central portion.

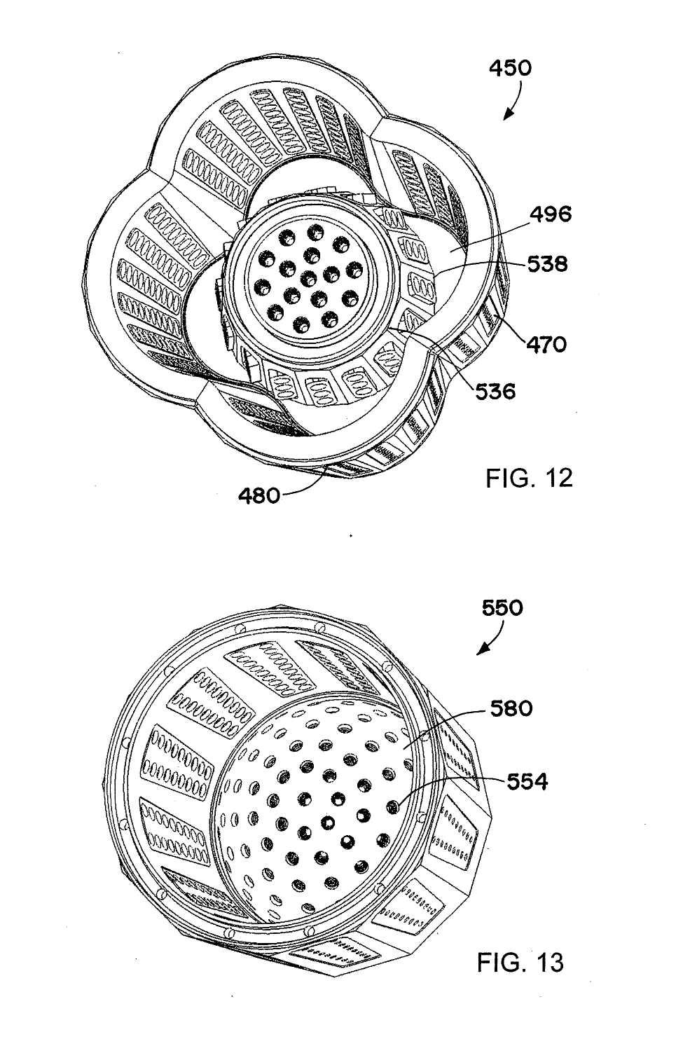

Turning now to FIG. 12, an exemplary embodiment of the injector is shown at 450. The injector of FIG. 12 is substantially the same as the above-referenced injector 250, and consequently the same reference numerals but indexed by 200 are used to denote structures corresponding to similar structures in the injectors. In addition, the foregoing description of the injector 250 is equally applicable to the injector 450 except as noted below. Moreover, it will be appreciated upon reading and understanding the specification that aspects of the injectors may be substituted for one another or used in conjunction with one another where applicable.

Referring now to FIG. 12, the injector 450 includes an end wall 496 extending radially outwardly from the first axial end 538 of the second support structure 536 does not house injector modules. Additionally, the support structure 480 has a four leaf clover-like shape, and the injector modules 470 housed in the support structure 480 direct an air and fuel mixture substantially in a radially-inward direction toward the main axis A.

Turning now to FIG. 13, an exemplary embodiment of the injector is shown at 550. The injector of FIG. 13 is substantially the same as the above-referenced injector 50, and consequently the same reference numerals but indexed by 500 are used to denote structures corresponding to similar structures in the injectors. In addition, the foregoing description of the injector 50 is equally applicable to the injector 550 except as noted below. Moreover, it will be appreciated upon reading and understanding the specification that aspects of the injectors may be substituted for one another or used in conjunction with one another where applicable.

Referring now to FIG. 13, the injector 550 includes an end wall that is a semispherical wall 580 extending into the inner chamber. The semispherical wall 580 does not include injector modules, but instead is formed having a plurality of micro-mixing nozzles 554. The wall may include one or more passages for receiving fuel from one or more fuel manifolds, which may be integral with or separate from the wall, and for delivering the fuel to the micro-mixing nozzles 554. For example, the wall may include a first passage for receiving a pilot circuit and a second passage for receiving a main circuit. The wall may be fabricated in any suitable manner, such as by macrolamination, rapid prototyping, casting, machining, a combination thereof, etc., and may be formed from one or more components joined in any suitable manner, such as by welding, brazing etc. Additionally, the support structure 580 may be cylindrical or conical as described above.

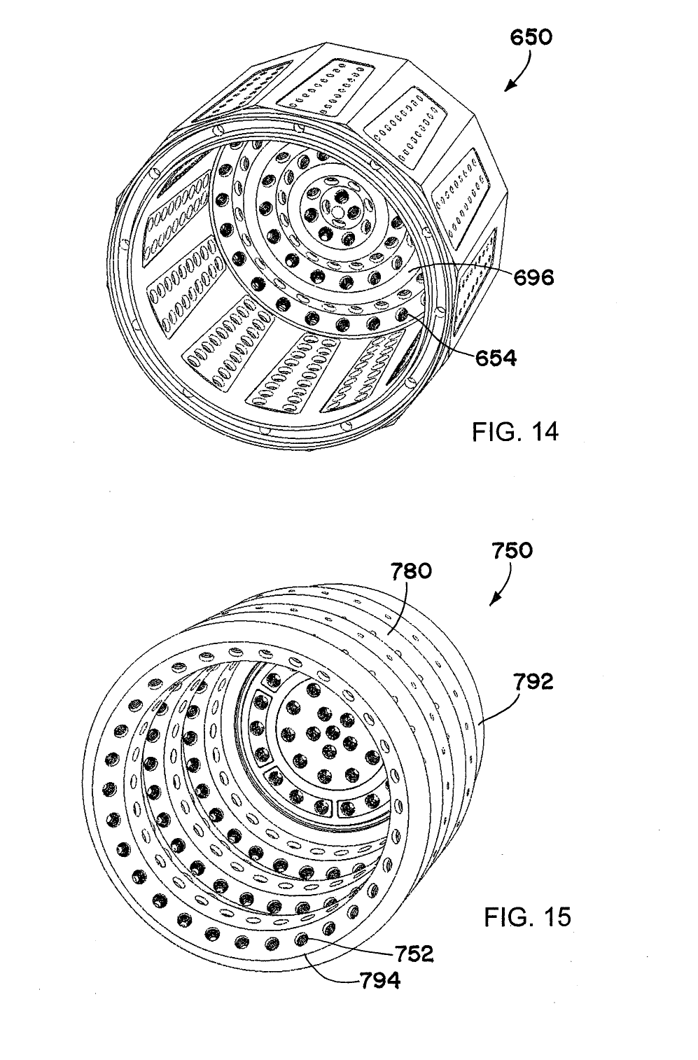

Turning now to FIG. 14, an exemplary embodiment of the injector is shown at 650. The injector of FIG. 14 is substantially the same as the above-referenced injector 550, and consequently the same reference numerals but indexed by 100 are used to denote structures corresponding to similar structures in the injectors. In addition, the foregoing description of the injector 550 is equally applicable to the injector 650 except as noted below. Moreover, it will be appreciated upon reading and understanding the specification that aspects of the injectors may be substituted for one another or used in conjunction with one another where applicable. Referring now to FIG. 14, the injector 650 includes an end wall 696 that includes a plurality of micro-mixing nozzles 654 arranged in concentric rings along the end wall that may be at various angles relative to the main axis A.

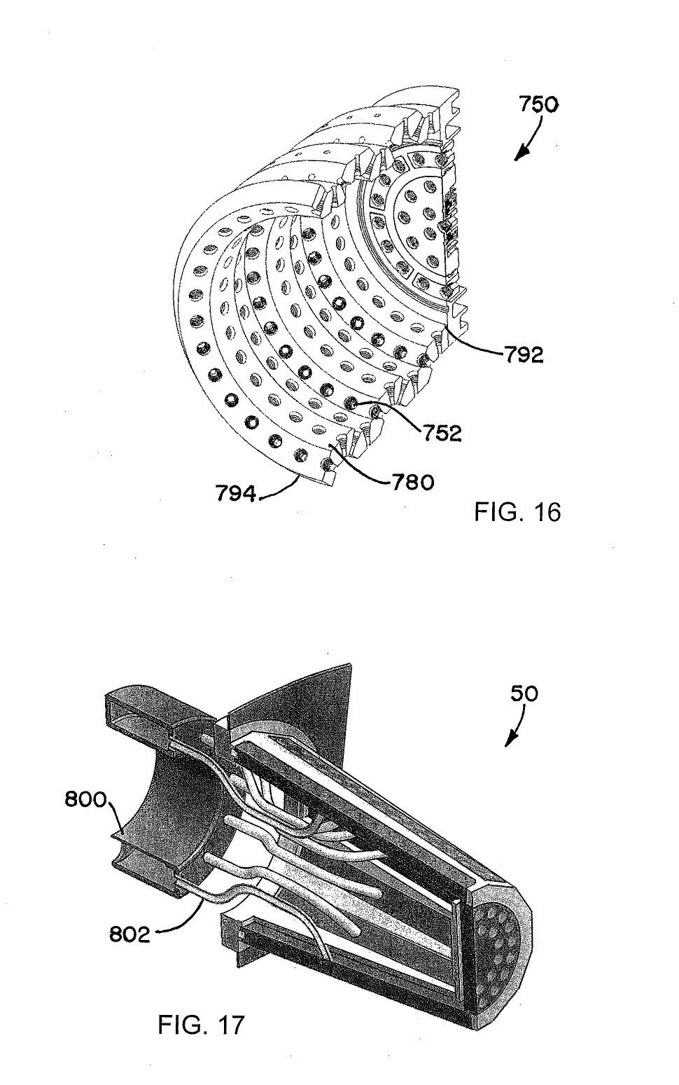

Turning now to FIGS. 15 and 16, an exemplary embodiment of the injector is shown at 750. The injector of FIGS. 15 and 16 is substantially the same as the above-referenced injector 50, and consequently the same reference numerals but indexed by 700 are used to denote structures corresponding to similar structures in the injectors. In addition, the foregoing description of the injector 50 is equally applicable to the injector 750 except as noted below. Moreover, it will be appreciated upon reading and understanding the specification that aspects of the injectors may be substituted for one another or used in conjunction with one another where applicable.

Referring now to FIGS. 15 and 16, the injector 750 includes a support structure 780 that does not include injector modules, but instead is formed having a plurality of micro-mixing nozzles 752. The micro-mixing nozzles 752 may be arranged in rings extending from the first axial end 792 to 794, and the surfaces of the rings, and therefore the nozzles, may be at various angles relative to the main axis A.

The support structure 780 may include one or more passages for receiving fuel from one or more fuel manifolds, which may be integral with or separate from the support structure, and for delivering the fuel to the micro-mixing nozzles 752. For example, the support structure may include a first passage for receiving a pilot circuit and a second passage for receiving a main circuit. The support structure may be fabricated in any suitable manner, such as by macrolamination, rapid prototyping, casting, machining, a combination thereof, etc., and may be formed from one or more components joined in any suitable manner, such as by welding, brazing etc. The support structure 780 may be cylindrical or conical as described above.

Turning now to FIGS. 17-19, cross-sectional perspective views of injectors 50, 150, and 350 are shown, respectively, coupled to manifold passages. As shown in FIG. 17, the injector 50 may be an inside-out injector wherein manifold passages 802 of manifold 800 are directly coupled to the injector modules 70 to deliver fuel to the passages in the injector modules. As shown in FIGS. 18 and 19, the injectors 150 and 350 may be outside-in injectors wherein manifold passages 802 of manifolds 800 are coupled to the support structures 190 and 390 to deliver fuel to the passages in the support structures.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. An injector comprising:
a first plurality of micro-mixing nozzles disposed in a circumferential array surrounding a main axis of the injector, wherein axes of the micro-mixing nozzles point radially inwardly with respect to the main axis; and
at least a second plurality of micro-mixing nozzles having axes thereof extending axially with respect to the main axis of the injector.

2. An injector according to claim 1, further comprising a plurality of injector modules each including one or more of the first plurality of micro-mixing nozzles.

3. An injector according to claim 2, wherein each injector module has associated therewith at least one passage for receiving fuel from a manifold.

4. An injector according to claim 2, further comprising a support structure for housing the plurality of injector modules, the support structure defining an inner chamber having first and second axial ends.

5. An injector according to claim 4, wherein the support structure includes at least one passage in communication with the plurality of injector modules for delivering metered fuel to first plurality of micro-mixing nozzles included in the plurality of injector modules.

6. An injector according to claim 4, further comprising an end wall enclosing the first axial end, the end wall housing the second plurality of micro-mixing nozzles.

7. An injector according to claim 1, wherein each micro-mixing nozzle has an inlet for receiving air, at least one slot in communication with a manifold for receiving fuel, a mixing chamber for at least partially mixing the air and fuel, and an outlet for delivering the air and fuel mixture.

8. An injector according to claim 1, further comprising:
a support structure for housing the first plurality of micro-mixing nozzles, the support structure defining an inner chamber having first and second axial ends; and
an end wall housing the second plurality of micro-mixing nozzles, the end wall enclosing the first axial end.

9. An injector according to claim 8, wherein the end wall is a semispherical wall extending into the inner chamber.

10. An injector according to claim 1, wherein the support structure has a conical configuration tapering outwardly from the first axial end to the second axial end.

11. An injector comprising:
a first plurality of micro-mixing nozzles disposed in a circumferential array surrounding a main axis of the injector, wherein axes of the micro-mixing nozzles point radially inwardly with respect to the main axis; and
a second plurality of micro-mixing nozzles disposed in a circumferential array surrounding the main axis of the injector and disposed interiorly of the first plurality of micro-mixing nozzles, wherein axes of the micro-mixing nozzles point radially outwardly with respect to the main axis.

12. An injector according to claim 11, further comprising
a first support structure for housing the first plurality of micro-mixing nozzles, the support structure defining an inner chamber having first and second axial ends; and
a second support structure for housing the second plurality of micro-mixing nozzles, the second support structure having first and second axial ends and projecting into the inner chamber from the first axial end of the first support structure.

13. An injector according to claim 12, further comprising an end wall extending radially outwardly from the first axial end of the second support structure, the end wall and second support structure enclosing the first axial end.

14. An injector according to claim 13, further comprising a second end wall enclosing a second axial end of the second support structure.

15. An injector according to claim 14, further comprising a plurality of micro-mixing nozzles housed in the second end wall, the nozzles having axes thereof extending axially with respect to the main axis of the injector.

16. An injector according to claim 12, further comprising a first plurality of injector modules each including one or more of the first plurality micro-mixing nozzles and a second plurality of injector modules each including one or more of the second plurality micro-mixing nozzles, wherein the first support structure houses the first plurality of injector modules and the second support structure houses the second plurality of injector modules.

17. An injector according to claim 16, wherein at least one of the plurality of first and second injector modules includes a first surface including a first set of micro-mixing nozzles and a second surface including a second set of micro-mixing nozzles, wherein the second surface is recessed relative to the first surface.

18. An injector according to claim 16, wherein at least one of the plurality of first and second injector modules includes:
a surface having an inner set of micro-mixing nozzles and an outer set of micro-mixing nozzles; and
a pilot sheltering baffle for at least partially sheltering a flame produced by the inner micro-mixing nozzles from air flow through the outer micro-mixing nozzles.

19. A method for enhancing flame stability of a flame in a cavity of an injector, the method comprising:
injecting a mixture of fuel and air from a first plurality of micro-mixing nozzles disposed in a circumferential array surrounding a main axis of the injector into the cavity, wherein axes of the micro-mixing nozzles point radially inwardly with respect to the main axis; and
injecting a mixture of fuel and air from at least a second plurality of micro-mixing nozzles having axes thereof extending axially with respect to the main axis of the injector into the cavity.

20. The method accord to claim 19, wherein when in a first power state the method comprises injecting the mixture of fuel and air from only the second plurality of micro-mixing nozzles, and when in a second power state greater than the first power state, the method comprises injecting the mixture of fuel and air from the first and second plurality of micro-mixing nozzles.
